(19) United States
(12) Patent Application Publication
(10) Pub. No.: US 2010/0328232 A1
(43) Pub. Date: Dec. 30, 2010

(54) Touch Screen Cursor Presentation Preview Window

(76) Inventor: James A. Wood, Charlottesville, VA (US)

Correspondence Address: BRUCE B. BRUNDA;STETINA BRUNDA GARRED 7 BRUCKER, 75 ENTERPRISE, SUITE 250, ALISO VIEJO, CA, 92656, US

(21) Appl. No.: 12/494,892

(22) Filed: Jun. 30, 2009

(51) Int. Cl. G06F 3/041

(52) U.S. Cl. 345/173

(57) ABSTRACT

An interactive user interface method for touch screen display devices begins with displaying a graphical user interface thereon. Upon receiving a touch input, a cursor preview window is generated in response, which includes a representation of a section of the graphical user interface proximal to the section obstructed by the touch input. Additionally, the cursor preview window includes a preview cursor that represents the location or coordinates that are registered as inputs to a data processing system connected to the touch screen display.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to touch screen user interfaces. More particularly, the present invention relates to methods and systems for touch screen cursor presentation preview windows for improved input accuracy.

2. Related Art

Touch screen displays are frequently utilized in user-operable electronic devices such as personal computers, point-of-sale (POS) devices, cellular phones, portable gaming devices and the like to provide intuitive and accurate interaction with the graphical user interfaces (GUIs) thereof. The touch screen display simultaneously functions as both an input device and an output device. Though the touch screen display is often integrated into the overall configuration of the aforementioned electronic devices, it is generally considered a peripheral device in that the touch screen display itself does not generate the data associated with the graphics being displayed or process the input data received. As such, the touch screen display typically replaces conventional input devices such as the keyboard and mouse, as well as conventional display devices such as Liquid Crystal Display (LCD) screens and Cathode Ray Tube (CRT) monitors. The central processing module executes pre-programmed instructions of the device operating system and the software applications that provide the functionality of the device.

Graphical elements representative of a user interface are generated by the central processing module and displayed by the touch screen display. For example, the central processing module may generate a button user interface element that is shown in a particular display area of the touch screen display. Further, the touch screen display detects touch inputs, which are converted to an electrical signal corresponding to the coordinates of the touched location relative to the input area. Continuing with the above example of the button, when a touch is sensed on the touch screen display in the area corresponding to the display area of the button, an instruction indicating that the button has been pressed is transmitted to the central processing module. This signal or instruction is transmitted to the central processing module as an input to the operating system or to the applications. The execution sequence of the pre-programmed instructions is then modified by the input. Specifically, the central processing module executes instructions that provide the functionality associated with the activation of the button.

A number of different types of touch screen display technologies employing various sensing principles are known in the art, including resistive, capacitive, and infrared, and strain gauge, among others. However, all such variations essentially provide the same input/output functionality to a central processing module as described above.

There are two major deficiencies in using touch screen displays for input/output purposes. First, the display beneath the area of the screen that is in contact with a user's finger is obscured. Second, the accuracy of the input is lacking compared to other graphical input devices such as mice or digitizer pens.

In order to address these deficiencies, various modifications have been proposed. The touch screen display may be calibrated such that the cursor is offset relative to the point on the screen that is actually touched. While increasing touch accuracy and visibility of the cursor, this solution limits the usability or accessibility of the corner regions of the screen. Additionally, it is not possible to directly click or touch the desired GUI elements, but must take the time to position the cursor in the proper location offset to the element. This significantly reduces the speed of operation.

Another solution proposes to increase the size of the GUI elements on the screen. Accuracy is increased by accommodating a greater active area for each element, and increasing the likelihood that the actually touched area on the screen corresponds to the desired area of the GUI element. However, by increasing its size, for a given screen size, fewer elements may be displayed simultaneously. Furthermore, where the software application is not limited to a specific device such as cellular phones, PDAs, machine control interfaces and the like, but is instead configured to execute on general purpose computers where input may also be provided through a conventional input device such as the mouse, the interface is unduly restricted to accommodate such larger GUI elements. Otherwise, a separate GUI must be developed for such different input devices.

Accordingly, there is a need in the art for touch screen display user interface and method for increasing the accuracy and precision of the touch inputs thereon, while retaining the interface designed for more accurate input devices. Additionally, there is a need in the art for a touch screen display user interface in which the user can immediately discern where the cursor is positioned even while it remains obscured.

### BRIEF SUMMARY

An interactive user interface method in accordance with one embodiment of the present invention includes displaying a graphical user interface on a touch screen display device. The touch screen display device may be defined by a display area and an input area coextensive therewith. The method may also include the step of receiving a user input through the input area of the touch screen display device. The user input may mask a segment of the display area of the touch screen display device. Further, the method may also include the step of overlaying a cursor preview window on the graphical user interface in response to the user input. The cursor preview window may include a representation of a section of the graphical user interface proximal to the masked segment of the display area. Additionally, the cursor preview window may include a preview cursor positioned in a central region of the section. The graphical user interface may include at least one active interface element associated with initiating an instruction sequence. This instruction sequence may be initiated upon the preview cursor being navigated to a representation of the active interface element in the cursor preview window, and registering an appropriate input. This method improves accuracy and precision in touch screen input without any substantial modifications to existing mouse-based graphical user interfaces. The cursor preview window provides a view of the cursor and its exact location even with the touch screen display being obstructed by the user.

In accordance with another embodiment of the present invention, a user interface system for a touch screen display device may include an input processing module and a preview module. The input processing module is connected to the touch screen display device, and derives input location coordinates that are representative of one position in an array of touch-sensitive positions of the touch screen display device. The preview module may generate a cursor preview window that includes a reproduction of a selected segment of the graphics displayed on the touch screen display device. The selected segment may be defined by a bounded area within a predefined proximity of the input location coordinates.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a hardware block diagram of a data processing device cooperating with a touch screen display device;

FIG. 2 is an exemplary graphical user interface as displayed on the touch screen display device;

FIG. 3 is a flowchart illustrating a user interface method in accordance with an embodiment of the present invention;

FIG. 4 is a selected view of the graphical user interface with a section thereof being obscured by user input;

FIG. 5 is a detailed block diagram of the user interface system, including the input processing module, the preview module, the interface module, and the output display module;

FIG. 6 is an exemplary cursor preview window according to one embodiment of the present invention; and

FIG. 7 is a flowchart depicting the sequence of steps taken after user input ceases.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions of the invention in connection with the illustrated embodiment. It is to be understood, however, that the same or equivalent functions and may be accomplished by different embodiments that are also intended to be encompassed within the scope of the invention. It is further understood that the use of relational terms such as first, second, and the like are used solely to distinguish one from another entity without necessarily requiring or implying any actual such relationship or order between such entities.

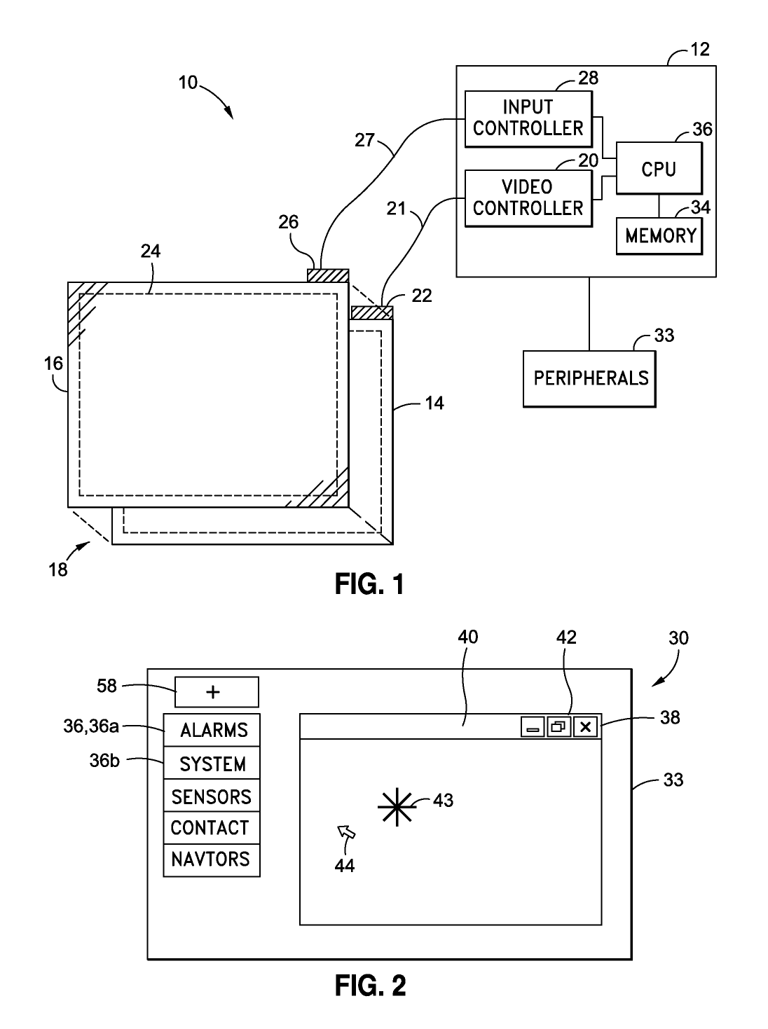

With reference to FIG. 1, an exemplary data processing apparatus 10 includes a main processing module 12. The output from the main processing module 12 is displayed on a display panel 14, while input to the main processing module 12 is received through the touch input panel 16. Together, the display panel 14 and the touch input panel 16 constitute a touch screen display device 18. According to one embodiment of the present invention, the display panel 14 is a conventional Liquid Crystal Display (LCD) screen, though any other type of video display screen such as Cathode Ray Tube (CRT) displays may be readily substituted. Further, the touch input panel 16 is of the capacitive type, however, any other type such as resistive, strain gauge, infrared, or the like may be utilized instead.

As will be readily appreciated by those having ordinary skill in the art, the display panel 14 is comprised of a plurality of pixels arranged in an array of rows of columns. Each of the pixels is addressable according to a coordinate system to activate or deactivate it. In combination with specific neighboring pixels at specific illumination levels, an image may be reconstructed. The main processing module 12 includes a video controller 20 that generates a video stream representative of the graphics to be reproduced on the display panel 14. The video stream is communicated over a video bus 21, which may conform to any one of well-known standards such as Video Graphics Array (VGA), Digital Visual Interface (DVI), and so forth. The display panel 14 may include a display controller 22 that receives the video signals from the video controller 20, and activates or deactivates the individual pixels on the display panel 14 based thereupon.

According to one embodiment as indicated above, the touch input panel 16 is of the capacitive type, in which a continuous electrical field is conducted across the surface area thereof. When the electrical field or capacitance is altered by the user's electrical field, this distortion is measured to derive positional information of the input. Operational characteristics of other touch screen types mentioned above will be readily ascertained by those having ordinary skill in the art. Generally, any touch screen type is understood to sense the specific location that is touched by the user, and supply the Cartesian coordinates of that location. The coordinates are in reference to a touch-sensitive area 24 of the touch input panel 16. In this regard, the touch sensitive area 24 may be considered to be an array of points arranged in rows and columns, with each point being represented by a set of coordinates. The number of points in the entirety of the touch sensitive area 24 is dependent on a number of factors, including the resolution of the sensors or analog-to-digital converters that detect the electrical field distortions. Upon deriving the touch coordinates, a touch screen controller 26 communicates the data to an input controller 28 on the main processing module 12 via an input bus 27. The input bus 27 may be compliant with the Universal Serial Bus (USB) standard, or any other peripheral device interconnect standard. In this regard, the input controller 28 and the touch screen controller 26 may have incorporated therein a sub-controller responsible for generating the signals compliant with such standards.

As described above, the touch screen display device 18 is comprised of the display panel 14 and the touch input panel 16. The touch screen display device 18 is overlaid on the display panel 14, and the touch-sensitive area 24 is substantially the same size as the active pixels on the display panel, for reasons that will become more apparent below. In order to maximize visibility of the graphics displayed on the display panel 14, the touch input panel 16 is transparent.

It is understood that the data processing apparatus 10 can be any interactive electronic device such as personal computers, industrial control systems, cellular telephones, and so forth. In this regard, the touch screen display device 18, together with the main processing module 12, is understood to provide the modality by which the user interacts with and initiate the various functions associated with the device. Referring to FIG. 2, the data processing apparatus 10, specifically, and by way of example only, the main processing module 12 is a general-purpose personal computer that provides interactive computing facilities through a graphical user interface (GUI) 30. With further specificity, the main processing module 12 includes a central processing unit 32 and a memory 34 for temporary and/or permanent data storage. Additionally, the main processing module 12 includes optional external peripherals 31, which may include such devices as keyboards, mice, scanners, printers, and the like.

The main processing module 12 or personal computer may utilize any operating system having the GUI 30, such as MICROSOFT WINDOWS®, APPLE MACOS®, UNIX operating systems utilizing X Windows, and so forth. It is understood that other, more light weight operating systems may be used for basic embedded control applications. The central processing unit 32 executes one or more computer programs that provide functionality in addition to that of the operating system. Generally, the operating system and the computer programs are tangibly embodied in a computer-readable medium, e.g. one or more of the fixed and or removable data storage devices. Both the operating system and the computer programs may be loaded from such data storage devices into the memory 34 for execution by the CPU 32. The computer programs comprise instructions which, when read and executed by the CPU 32, cause the same to perform the steps necessary to execute the steps or features of the present invention.

Referring to FIG. 2, the exemplary GUI 30 is defined by an underlying desktop 33. Layered above the desktop 33 is a set of buttons 36 arranged in an aligned column. Each of the buttons 36 includes a text descriptor therein, and activation of a particular one of the buttons 36 initiates the execution of an instruction sequence related to its text descriptor. For example, activating the “alarms” button 36a may activate program functionality related to alarms such as setting the alarm conditions. Furthermore, the exemplary GUI 30 includes a primary application window 38 overlaid on the desktop 33, and may include a menu bar 40 with window controls 42 that minimize, expand, or close the window 38. The primary application window 38 may also include a graphical object 43 that may be moved about therein. There is also a cursor 44, which may be navigated to the various interactive elements of the GUI 30. The cursor 44 is also understood to indicate the location within the display panel 14 to which the input is directed. As will be recognized by those having ordinary skill in the art, with conventional, mouse-based input, when the cursor 44 is hovering over an interactive element, activation of the same is accomplished by single clicking or double clicking the mouse button. Movable objects may be manipulated by first holding down one of the mouse buttons while “dragging” the mouse. With touch-based input, the touch sensitive area 24 may be tapped and dragged in similar ways, and it will be recognized that any mouse-based interfacing techniques are equally applicable to touch-based interfacing techniques. Further details pertaining to the touch-based interaction with the interactive elements of the GUI 30 will be described below.

One embodiment contemplates the desktop 33 having a border co-extensive with that of the active pixels of the display panel 14, as well as that of the touch-sensitive area 24 on the touch input panel 16. As such, the coordinates generated from any touch input will be recognized as referring to a point on the display panel 14 directly underneath it. The touch input panel 16 is aligned with the display panel 14 so that interaction with the displayed GUI 30 is precise and accurate. It is understood that minor deviations may be corrected through a calibration process.

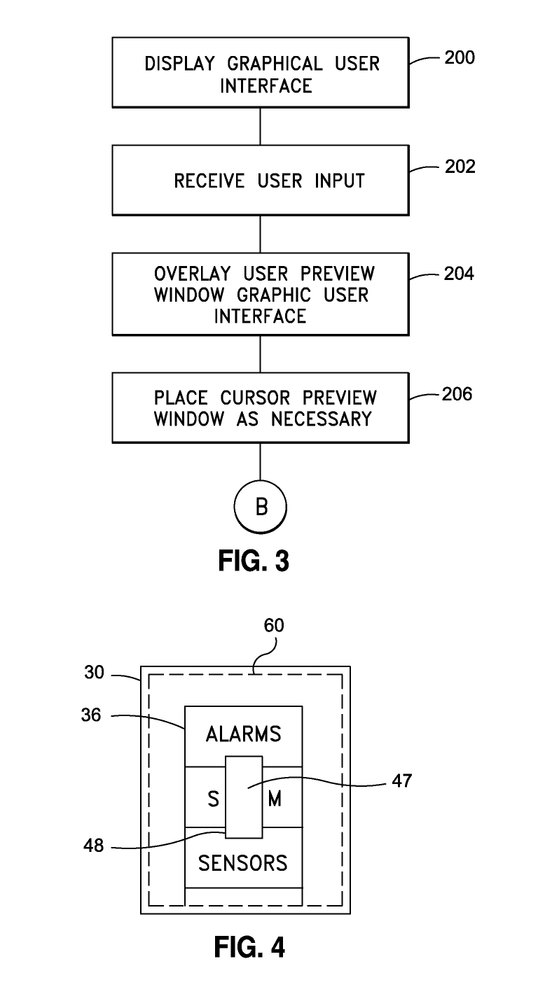

Having described the basic features of the data processing apparatus 10, including the display panel 14, the touch input panel 16, further details of the user interface system and method in accordance with one embodiment of the present invention will be considered. With reference to the flowchart of FIG. 3, and with additional reference to FIGS. 1 and 2, the method begins with a step 200 of displaying the graphical user interface 30 on the touch screen display device 18. As indicated above, the display area or boundary of the desktop 33 is coextensive with the touch sensitive area 24 of the touch input panel 16.

The method continues with a step 202 of receiving a user input through the touch sensitive area 24 of the touch input panel 16. As best illustrated in the exemplary view of the graphical user interface 30 in FIG. 4, the user input masks a segment 46 thereof from view when the user touches the touch input panel 16. In other words, the portion of the display panel 14 directly underneath the user is obstructed.

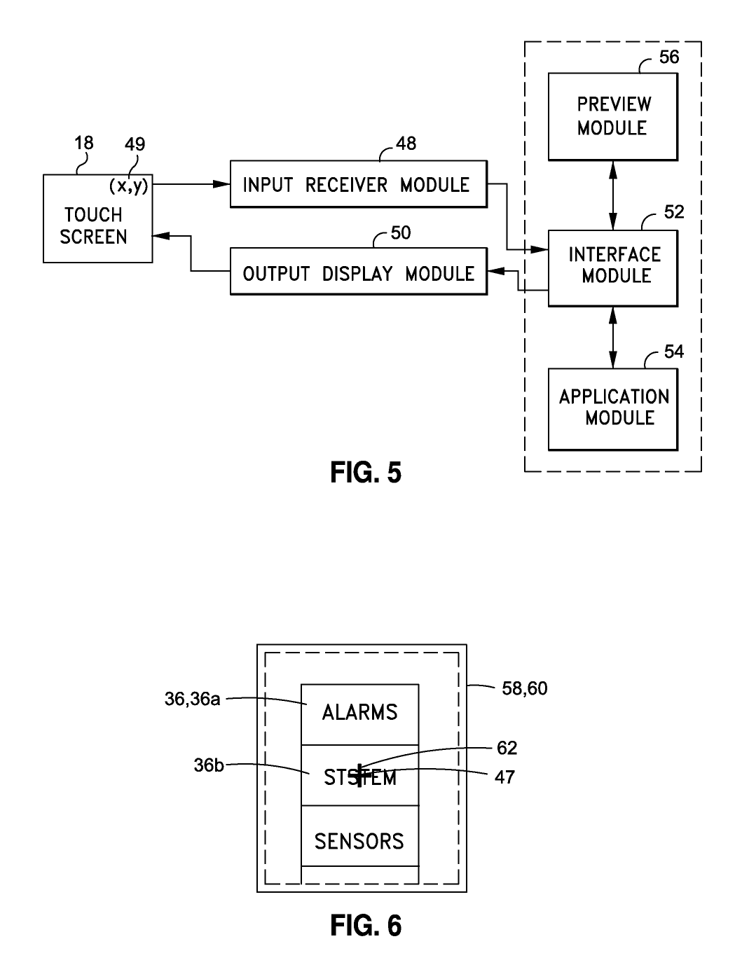

Although the data processing apparatus 10 in accordance with one embodiment of the present invention has been described above in relation to the various hardware features thereof, it may also be conceptualized as functional blocks as shown in the diagram of FIG. 5. Specifically, the touch screen display device 18 is in communication with an input receiver module 48, and an output display module 50. The input receiver module 48 receives touch input coordinates 49 as sensed by the touch input panel 16. As mentioned above, the touch input coordinates 49 are representative of the relative location that the user has touched, amongst the other points of the touch sensitive area 24. An interface module 52 generates the graphical user interface 30 including the desktop 33 and the buttons 36. By way of example, the primary window 38 is generated by an application program separate from the operating system. In this regard, an independent application module 54 handles the generation of graphics specific to the primary window 38, and instructions relating thereto are passed through the interface module 52 to the output display module 50. However, it will be appreciated that certain basic processing of the primary window 38 is handled by the interface module 52, including the specificities relating to common elements such as the menu bar 40 and the window controls 42. As the touch inputs are received, they are converted to the touch input coordinates 49 and transmitted to the interface module 52. The output module 50 generates graphics signals representative of the graphical user interface 30 as specified by the interface module 52, for transmission to the touch screen display device 18.

Referring again to the flowchart of FIG. 3, the method continues with a step 204 of overlaying a cursor preview window 58 on the graphical user interface 30. According to one embodiment of the present invention, this step is performed in response to a specific touch input. It is contemplated that this touch input is maintaining a sustained pressure upon the touch-sensitive area 24 for a predetermined time period of anywhere between half a second to three seconds, though any suitable time period may be substituted without departing from the scope of the present invention. Along these lines, short, sporadic touches of the touch input panel 16, despite being sensed, are insufficient to trigger this step. With reference to FIGS. 4 and 6, the cursor preview window 58 includes a representation of a section of the graphical user interface 30 proximal to the masked segment 46, also referred to as a bounded area 60. Essentially, the cursor preview window 58 contains a copy of the section of the graphics being displayed on the display panel obscured by the touch input. Further, the bounded area 60 typically includes graphics from areas beyond that obscured by the touch input, up to a predetermined limit. The aforementioned section or bounded area 60 may be square or rectangular in shape, though any other displayable shape such as a circle or oval may also be utilized. It is understood that the borders of the bounded area 60 are a predefined distance from a center 47 of the masked segment 46. The center 47 corresponds to the touch input coordinates 49 as sensed by the touch input panel 16. For reasons that will be described in further detail below, the cursor preview window 58 includes a cross-hair cursor 62 disposed at the center 47.

As shown in the functional block diagram of FIG. 5, there is a preview module 56 in communication with the interface module 52. It is contemplated that the step of generating the cursor preview window 58 is performed by the preview module 56 upon being directed to do so by the interface module 52. Though the cursor preview window 58 may be variously positioned on the graphical user interface 30, in the exemplary embodiment shown in FIG. 2, it is overlaid on the upper-left hand corner thereof. The position of the cursor preview window 58 may be static according to one embodiment, though dynamic positioning is also contemplated. More particularly, the cursor preview window 58 may be positioned in relatively close proximity to the masked segment 47 to such an extent that it is not obscured by the user. Along these lines, the cursor preview window 58 may be dynamically repositioned so as to track the user's touch input.

It is understood that the preview module 56 extracts the relevant section of the graphical user interface 30 based upon the touch input coordinates 49, and combines it with the underlying graphical user interface 30. The size of the cursor preview window 58 may be adjusted to accommodate various aesthetic considerations, such as ensuring that it be no larger than a certain percentage of the overall size of the desktop 33 to reduce user distraction. Thus, according to one embodiment, the cursor preview window 58 is about 10% of the size of the desktop 33. In order to improve the visibility of the graphics reproduced in the cursor preview window 58, it may be enlarged by a predetermined zoom factor. Preferably, though optionally, this zoom factor is 1.5×. It is also contemplated that no zoom factor be applied.

In accordance with one embodiment of the present invention, the cursor preview window 58 is updated on a regular interval as the input coordinates 49 change according to step 206. Essentially, the graphics displayed in the cursor preview window 58 moves in accordance with the touch input as it shifts around the touch sensitive area 24. Though it will be appreciated that alternative interaction methods may be readily substituted, in the presently described embodiment, pressure on the touch-sensitive area 24 continues to be maintained while moving to a different segment thereof. In further detail with reference to FIG. 5, it is understood that the touch screen display 18 transfers a constant stream of input coordinates 49 to the input receiver module 48 on a predefined interval. Alternatively, the input receiver module 48 may poll the touch input panel 16 at a predefined interval, capturing the input coordinates 49 (if any) at that given instant in time. In either case, the predefined interval is understood to be relatively short, in the milliseconds range, so as to prevent any perceived delays in registering the touch input. At each predefined interval where there is a difference between the currently received input coordinates 49 and previously received input coordinates 49, the interface module 52 adjusts the position of the cursor 44. The interface module 52 signals to the preview module 56 that the touch input has moved, whereupon the graphics in the cursor preview window 58 are updated.

As indicated above, the various interactive elements of the graphical user interface 30, including the buttons 36 and the graphical object 43, have specific functionality associated therewith. This functionality may be invoked upon activation of the interactive element through various known modalities commonly implemented in graphical user interfaces. With specific regard to the buttons 36, the user may direct the cursor 44 thereto and quickly tap the section of the touch input panel 16 that corresponds to the displayed button 36. This initiates processing of executable instructions specific to the activated button 36. Alternatively, the cursor 44 may be “dragged” to the button 36, that is, the user maintains pressure on the touch input panel 16 while maneuvering to the desired point. Typically, such maneuvers are minuscule and extend only short distances because the cursor 44 has already been positioned in the general vicinity of the desired interactive element. In order to provide greater resolution for these minute movements, a compensation factor may be applied to the changing user input, such that a greater distance must be traversed on the touch input panel 16 to obtain a corresponding movement of the cursor 44 on the graphical user interface 30. Once the cursor 44 is properly positioned, the pressure on the touch input panel 16 is released. Upon release, the processing of the executable instructions specific to the activated button 36 begins. It will be recognized that without visually confirming that the cursor 44 is indeed placed over the desired interactive element, it is difficult to ascertain whether the desired instruction sequence will be executed. This is particularly problematic for touch screen interfaces because a large portion of the interactive element may be obstructed. For example, in attempting to activate the “alarms” button 36a, the “system” button 36b may accidentally be activated. In this regard, the cursor preview window 58 aids the user by showing exactly where the input, or the release of pressure upon the touch input panel 16, will be registered. The crosshair cursor 62 is contemplated to represent the input coordinates 49 that will be generated upon release.

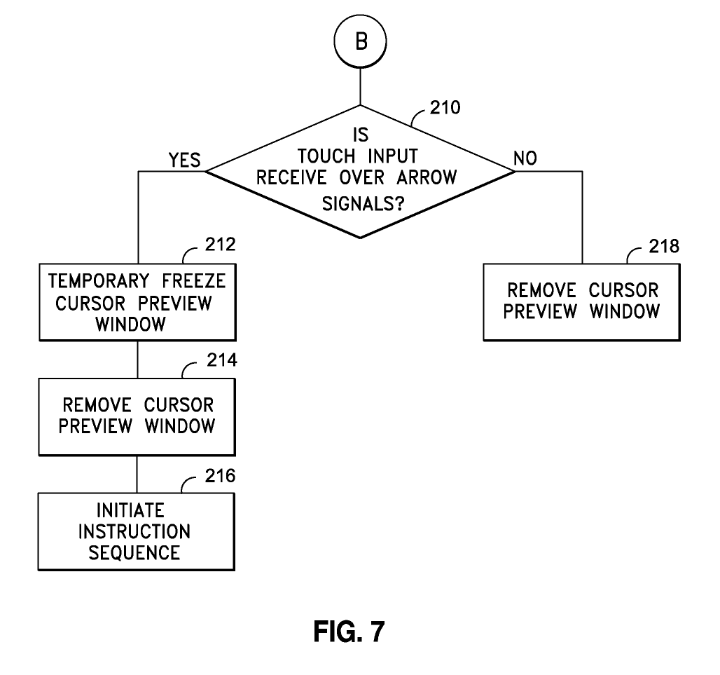

With reference to the flowchart of FIG. 7, upon release of the touch input, there is a decision block 210 which ascertains whether the input was registered while the cursor 44 was positioned over an interactive element or not. If it was, in order to alert the user that the interactive element was activated, according to step 212, the cursor preview window 58 and the graphic contents thereof are temporarily frozen for a predetermined time. According to one embodiment of the present invention, the predetermined time is approximately 1 second, though it may be expanded or contracted depending on the circumstances or as defined by the preferences of the user. After the expiration of the predetermined time, the cursor preview window 58 is removed from the graphical user interface 30 per step 214. Thereafter, according to step 216, the aforementioned instruction sequence is initiated. If the input was registered while the cursor 44 was not positioned over an interactive element, according to step 218 the cursor preview window 58 may be immediately removed. It will be appreciated by those having ordinary skill in the art that the foregoing steps of freezing and removing the cursor preview window 58 are optional. Thus, the cursor preview 58 may be permanently displayed on the desktop 33. As indicated above, processing related to the cursor preview window 58 are embodied in the preview module 56.

The graphical object 43 may also provide similar interaction capabilities as described above in relation to the buttons 36, where “tapping” it invokes additional program functionality. In addition, the graphical object 43 may be moved from one location within the primary window 38 to another. Along these lines, it is understood that any other graphical objects on the graphical user interface 30, such as the desktop 33, may also be moved about. There are various known ways for interacting with movable objects on the graphical user interface, including “tapping” on the object, moving the object to the desired location, and “tapping” again, which releases the object from any further movement. Alternatively, the user may continuously “hold” the object by maintaining pressure against the touch input panel 16, and moving it to the desired location. Upon reaching the desired location, the pressure against the touch input panel 16 is released, thereby releasing the object from further movement. It is contemplated that the cursor preview window 58 functions in the same manner as described above in relation to the buttons 36, where movement of the touch input is reflected in the cursor preview window 58, and a release of the touch input causes the cursor preview window 58 to be removed from the graphical user interface 30.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. An interactive user interface method comprising:
displaying a graphical user interface on a touch screen display device defined by a display area and an input area coextensive therewith;
receiving a user input through the input area of the touch screen display device, the user input masking a segment of the display area of the touch screen display device; and
overlaying a cursor preview window on the graphical user interface in response to the user input, the cursor preview window including a representation of a first section of the graphical user interface proximal to the masked segment of the display area, and a preview cursor positioned in a central region of the first section.

2. The method of claim 1, wherein the representation of the section of the graphical user interface is enlarged by a predetermined zoom factor.

3. The method of claim 2, wherein the zoom factor is 1.5×.

4. The method of claim 1, wherein the size of the cursor preview window is a predetermined percentage of the display area.

5. The method of claim 1, wherein the user input is sustained pressure upon the input area of the touch screen display device for a first predetermined time period.

6. The method of claim 5, wherein the graphical user interface includes at least one active interface element associated with initiating an instruction sequence.

7. The method of claim 6, further comprising:
initiating the instruction sequence upon the preview cursor being navigated to a representation of the active interface element in the cursor preview window and the pressure upon the input area of the touch screen display device being released.

8. The method of claim 7, wherein prior to initiating the instruction sequence, the method further includes:
freezing the cursor preview window for a predetermined time after the user input ceases; and
removing the cursor preview window from the display area of the touch screen display device.

9. The method of claim 1, further comprising:
updating the representation of the section of the graphical user interface in response to a different segment of the display area being masked as a result of changing user input.

10. The method of claim 9, wherein the changing user input is sustained pressure upon the input area of the touch screen display device while moving to an alternative segment of the input area.

11. The method of claim 9, wherein the cursor preview window is overlaid on the graphical user interface in a static position of the display area.

12. The method of claim 9, wherein:
the cursor preview window is overlaid on the graphical user interface in a position proximate to the masked segment; and
the position of the cursor preview window being adjusted in conjunction with the representation of the section of the graphical user interface.

13. A user interface system for a touch screen display device comprising:
an input processing module connected to the touch screen display device for deriving input location coordinates associated with touch inputs sensed by the touch screen display device, the input location coordinates being representative of one position in an array of touch-sensitive positions of the touch screen display device; and
a preview module for generating a cursor preview window including a reproduction of a selected segment of graphics being displayed on the touch screen display device, the selected segment being defined by a bounded area within a predefined proximity of the input location coordinates.

14. The user interface system of claim 13, wherein the cursor preview window is generated upon a touch input being sensed for a predefined duration.

15. The user interface system of claim 13, wherein the cursor preview window includes a preview cursor in a central region thereof.

16. The user interface system of claim 13, wherein the reproduction of the selected segment of graphics in the cursor preview window is enlarged by a predefined zoom factor relative to an original of the selected segment of graphics.

17. The user interface system of claim 16, wherein the zoom factor is 1.5×.

18. The user interface system of claim 13, wherein the size of the cursor preview window is a predetermined percentage of the touch screen display device.

19. The user interface system of claim 13, wherein the cursor preview window is updated on a regular interval as the touch input traverses the array of positions of the touch screen display device.

20. The user interface system of claim 13, further comprising:
an interface module for generating the cursor preview window and a graphical user interface including at least one interactive element, each component of the graphical user interface constituting the graphics being displayed on the touch screen display device; and
an output module for generating graphics signals representative of the cursor preview window and the graphical user interface, the graphics signals being transmitted to the touch screen display device.

21. The user interface system of claim 20, wherein a processing instruction associated with the interactive element is generated in response to a first input location coordinate derived from the sensed touch input being matched to the position of the interactive element.

22. A computer-readable medium having computer-executable instructions for performing a method comprising:
displaying a graphical user interface on a touch screen display device defining a display area and an input area coextensive therewith;
receiving a user input through the input area of the touch screen display device, the user input masking a segment of the display area of the touch screen display device;
and
overlaying a cursor preview window on the graphical user interface in response to the user input, the cursor preview window including a representation of a section of the graphical user interface proximal to the masked segment of the display area, and a preview cursor positioned in a central region of the section.

23. The computer readable medium of claim 22, wherein the method further includes the step of:
updating the representation of the section of the graphical user interface in response to a different segment of the display area being masked as a result of changing user input.
